(19) United States
(12) Patent Application Publication
(10) Pub. No.: US 2013/0089216 A1
(43) Pub. Date: Apr. 11, 2013

(54) METHOD AND APPARATUS FOR RECOGNIZING AN EARPHONE IN A PORTABLE DEVICE

(71) Applicant: SAMSUNG ELECTRONICS CO., LTD., Suwon-si (KR)

(72) Inventor: Kiwook HAN, Seoul (KR)

(73) Assignee: SAMSUNG ELECTRONICS CO., LTD., Suwon-si (KR)

(21) Appl. No.: 13/644,625

(22) Filed: Oct. 4, 2012

(30) Foreign Application Priority Data
Oct. 5, 2011 (KR) 10-2011-0101134

(51) Int. Cl. H04R 1/10

(52) U.S. Cl. 381/74

(57) ABSTRACT

A method and an apparatus for recognizing an earphone in a portable terminal are provided. The method includes detecting a connection to the earphone, recognizing a type of the connected earphone, determining whether a re-recognition signal of the connected earphone is input, and re-recognizing the type of the connected earphone when the re-recognition signal is input.

### PRIORITY

This application claims the benefit under 35 U.S.C. §119(a) of a Korean patent application filed on Oct. 5, 2011 in the Korean Intellectual Property Office and assigned Serial No. 10-2011-0101134, the entire disclosure of which is hereby incorporated by reference.

### BACKGROUND OF THE INVENTION

1. Field of the Invention

The present invention relates to a method and an apparatus for recognizing an earphone in a portable device. More particularly, the present invention relates to a method and an apparatus for recognizing an earphone in a portable device, in which a four pole earphone is prevented from being recognized as a three pole earphone when connected with a call key being pressed.

2. Description of the Related Art

Due to rapid advancement of information and communication technology and semiconductor technology, portable terminals are widely distributed and used. Recent portable terminals provide not only a traditional function but also an additional function of other terminals, such as TV, Digital Multimedia Broadcasting (DMB), Digital Video Broadcasting (DVB), or music playback (e.g., MPEG audio layer-3 (MP3)), in addition to general communication functions such as a voice call or messaging.

A portable terminal that provides such multimedia functions generally includes an earjack. The earjack may be connected to a three pole earphone and a four pole earphone. Accordingly, the portable terminal should be capable of recognizing a type of an earphone connected thereto to perform a function according to the recognized type of the earphone. In a portable terminal according to the related art, when connection to the earphone is detected, a voltage of a microphone terminal of the earjack is identified so that, when the voltage of the microphone terminal is equal to or higher than a predefined reference value, connection to the four pole earphone is recognized, and when the voltage of the microphone terminal voltage is less than the predetermined reference value, connection to the three pole earphone is recognized.

The four pole earphone includes a call key. The call key is positioned between the microphone terminal and a ground terminal of the earphone. When the call key is pressed, the microphone terminal and the ground terminal of the four pole earphone are connected to each other, and when the call key is not pressed, the microphone terminal and the ground terminal of the four pole earphone are disconnected from each other. Accordingly, when the four pole earphone is connected to the earjack while the call key is being pressed by the user, the portable terminal according to the related art erroneously recognizes that the three pole earphone is connected. Thus, when misrecognition of the connection to the three pole earphone occurs, the portable terminal does not recognize an operation of a microphone, a volume control key, or the call key of the four pole earphone. Accordingly, the user may mistakenly determine that the portable terminal or the four pole earphone is broken.

### SUMMARY OF THE INVENTION

Aspects of the present invention are to address at least the above-mentioned problems and/or disadvantages and to provide at least the advantages described below. Accordingly, an aspect of the present invention is to provide an apparatus and a method for recognizing an earphone of a portable terminal in which a type of an earphone is re-recognized when a predefined control signal is input so that, when an earphone is connected and is misrecognized, the type of the connected earphone may be correctly re-recognized at a certain time point.

In accordance with an aspect of the present invention, a method of recognizing an earphone in a portable terminal is provided. The method includes detecting a connection to the earphone, recognizing a type of the connected earphone, determining whether a re-recognition signal of the connected earphone is input, and re-recognizing the type of the connected earphone when the re-recognition signal is input.

In accordance with another aspect of the present invention, an apparatus for recognizing an earphone in a portable terminal is provided. The apparatus includes an earjack for connecting to the earphone, and a controller for recognizing a type of a connected earphone when connection to the earphone is detected, for determining whether a re-recognition signal of the connected earphone is input, and for controlling to re-recognize the type of the connected earphone when the re-recognition signal is input.

In accordance with another aspect of the present invention, a portable terminal is provided. The portable terminal includes an earjack arranged to receive a three pole earphone and a four pole earphone, a controller for recognizing a type of an earphone inserted into the earjack, for determining whether a re-recognition of the inserted earphone is input, and for re-recognizing the type of the inserted earphone when the re-recognition symbol is input, and an audio processor for receiving an audio signal input from a microphone of the inserted earphone, and for converting a data signal into an analog signal for output to the inserted earphone.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments the present invention will be more apparent from the following description taken in conjunction with the accompanying drawings, in which:

FIG. 1 is a schematic view illustrating an earphone and a portable terminal according to a first exemplary embodiment of the present invention;

FIG. 2 is a schematic view illustrating a configuration of an earphone and a portable terminal according to a second exemplary embodiment of the present invention; and

FIG. 3 is a flowchart illustrating a method of recognizing an earphone in a portable terminal according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, description of well-known functions and constructions may be omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for illustration purposes only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The exemplary embodiments illustrated in the drawings are intended only to exemplify the invention and should not be construed as limiting the invention to the illustrated embodiments. It will be apparent for a person skilled in the art that the present invention can be embodied in various forms without departing from the technical spirit thereof.

In the following description, a portable terminal according to an exemplary embodiment of the present invention may be an electronic device equipped with a four pole earjack such as, for example, a mobile communication terminal, a Personal Digital Assistant (PDA), a smart phone, a tablet Personal Computer (PC), a Portable Multimedia Player (PMP), or a notebook.

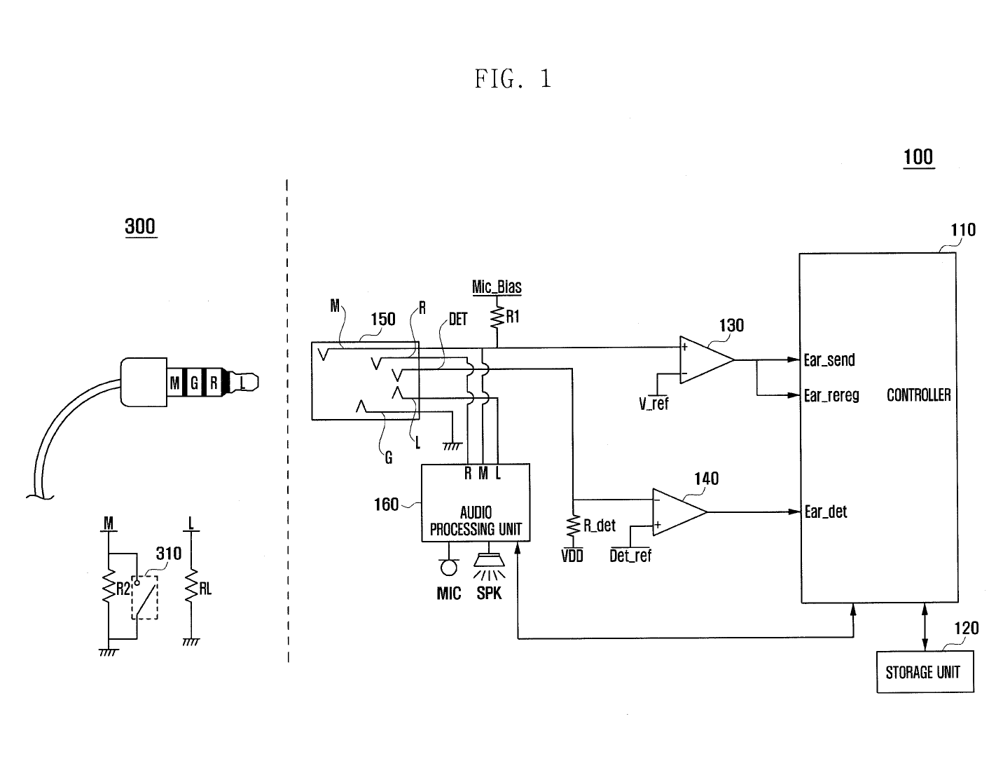

FIG. 1 is a schematic view illustrating an earphone and a portable terminal according to a first exemplary embodiment of the present invention. A three pole earphone and a four pole earphone are collectively referred to as an earphone and specifically distinguished from each other when appropriate.

Referring to FIG. 1, a four pole earphone 300 may be a general standard earphone. Such four pole earphone 300 may include a microphone terminal M, a ground terminal G, a right sound terminal R and a left sound terminal L. A microphone resistor R2 is serially connected to the microphone terminal M and a call key 310 is parallel connected to the microphone resistor R2. The left sound terminal L is serially connected to a left sound resistor RL. Although not shown in the drawings, the right sound terminal R is serially connected to a right sound resistor (not shown) and the ground terminal G is grounded. A structure of the four pole earphone 300 is well known to a person of ordinary skill in the art, and therefore, a detailed description thereof will be omitted.

The portable terminal 100 may include an audio processing unit 160, an earjack 150, an earphone detection unit 140, a call key recognition unit 130, a storage unit 120 and a controller 110.

The audio processing unit 160 may be formed in an audio component for performing encoding and decoding by transmitting and receiving an audio signal. The audio processing unit may include a codec and an audio amp. The audio processing unit 160 is connected to a microphone MIC and a speaker SPK. A voice signal received from the microphone MIC is converted to data to be transmitted to the controller 110. A voice signal input from the controller 110 is converted to an analog signal to be outputted through the speaker SPK. The audio processing unit 160 may also output various audio signals generated in the portable terminal 100, such as, for example, audio signals produced according to reproducing an MP3 file or a video file through the speaker SPK. When the earphone is connected to the portable terminal 100, the audio processing unit 160 may transmit an audio signal to the earphone through the left sound terminal L and the right sound terminal R of the earjack 150 or receive a voice signal input through the microphone terminal M of the earjack 150.

The earjack 150 may be a four pole standard earjack. Such earjack 150 may be connected to the three pole earphone (not shown) or the four pole earphone 300. The earjack 150 may include a body having a passage through which the earphone is inserted. A microphone terminal M, a ground terminal G, a right sound terminal R, a left sound terminal L, and a detection terminal DET disposed inside the body of the earjack 150. The microphone terminal M of the earjack 150, the ground terminal G of the earjack 150, the right sound terminal R of the earjack 150, the left sound terminal L of the earjack 150, and the detection terminal DET of the earjack 150 may be positioned to contact a terminal corresponding to the four pole earphone 300.

For example, when the four pole earphone 300 is completely inserted within the earjack 150, the ground terminal G of the earjack 150 may contact the ground terminal G of the four pole earphone 300, the right sound terminal R of the earjack 150 may contact the right sound terminal R of the four pole earphone 300, and the left sound terminal L of the earjack 150 may contact the left sound terminal L of the four pole earphone 300. The detection terminal DET of the earjack 150 may be connected to the left sound terminal L of the four pole earphone 300. The detection terminal DET of the earjack 150 is connected to the ground when the earphone is not connected thereto, and the connection to the ground may be canceled when the earphone is connected thereto. The microphone terminal M of the earjack 150 may be connected to the microphone terminal M of the four pole earphone 300. The microphone terminal M of the earjack 150 may also be connected to the call key recognition unit 130 for recognizing pressing of the call key 310. The microphone terminal M of the earjack 150 may be connected to a microphone bias power MIC_Bias through a pull up resistor R1. The microphone bias power MIC_Bias may be provided when earphone connection is detected.

Although FIG. 1 shows that the detection terminal DET of the earjack 150 is located corresponding to the left sound terminal L, exemplary embodiments of the present invention are not limited thereto. In other types of the earjack 150, the detection terminal DET may be located corresponding to the ground terminal G. In this case, the detection terminal DET of the earjack 150 may be disconnected to the ground when the earphone is not connected and may be connected to the ground when the earphone is connected.

The earphone detection unit 140 may detect earphone connection. The earphone detection unit 140 may be formed as a comparator. The earphone detection unit 140 may compare an output voltage of the detection terminal DET of the earjack 150 with a predefined reference voltage Det_ref to output a low signal or a high signal. For example, the earphone detection unit 140 may be configured to output the low signal when the earphone is not connected and output the high signal when the earphone is connected. The earphone detection unit 140 may alternatively be configured to output the high signal when the earphone is not connected and output the low signal when the earphone is connected. An output signal of the earphone detection unit 140 may be transmitted to a detection terminal Ear_det of the controller 110. The comparator and a method of detecting a connection of an external device by using the comparator are well known to a person of ordinary skill in the art, and therefore, a detailed description thereof will be omitted.

The call key recognition unit 130 may recognize the pressing of the call key 310 included in the four pole earphone 300. The call key recognition unit 130 may be formed as a comparator as shown in FIG. 1. The call key recognition unit 130 may compare an output voltage of the microphone terminal M of the earjack 150 and a predefined reference voltage V_ref to output a low signal or a high signal. The output voltage of the microphone terminal M of the earjack may be a microphone bias voltage MIC_Bias that is divided by a first resistor R1 and the microphone resistor R2 or the microphone bias voltage Mic_Bias that is divided by the first resistor R1 and the ground G. For example, the call key recognition unit 130 may be configured to output the low signal when the call key 310 is pressed and output the high signal when the call key 310 is not pressed. The call key recognition unit 130 may alternatively be configured to output the high signal when the call key 310 is pressed and output the low signal when the call key 310 is not pressed. An output signal of the call key recognition unit 130 according to an exemplary embodiment of the present invention may be provided to a call key recognition terminal Ear_Send and a re-recognition terminal Ear_rereg of the controller 110.

In FIG. 1, only the call key recognition unit 130 for recognizing the call key 310 is shown; however, exemplary embodiments of the present invention are not limited thereto. For example, the portable terminal 100 may include a plurality of key recognition unit for recognizing a volume control key, a music playback key, a next song playback key, a previous song playback key, a hold key, etc.

The storage unit 120 may include application programs used for an Operating System (OS) as well as other optional features, such as, for example, a sound playback function, an image or video playback function, a broadcast playback function, user data, and data transmitted and received during communication. The storage unit 120 may include an earphone recognition control program that controls earphone recognition. The earphone recognition control program may include, for example, a routine for detecting earphone connection, a routine for determining a type of a connected earphone, a routine for controlling an audio signal path according to the earphone connection, a routine for recognizing a key (e.g., the call key, the volume control key, or the music playback key), and a routine for re-determining the type of the earphone when a request for earphone re-recognition is generated.

The controller 110 may control an overall operation of the portable terminal 100 and control a signal flow between internal blocks of the portable terminal 100 to perform a data processing function for processing a data. The controller 110 may control the earphone recognition. The controller 110 may detect a connection to the three pole earphone or the four pole earphone through the detection terminal Ear_det. The controller 110 may recognize the earphone connection when a signal input to the detection terminal Ear_det is changed from a low signal to a high signal. Depending on a designer's intent, the controller 110 may alternatively recognize earphone connection when the signal input to the detection terminal Ear_det is changed from a high signal to a low signal.

When the earphone connection is detected, the controller 110 may activate the microphone bias power Mic_Bias and recognize the type of the earphone by determining the output voltage of the microphone terminal M of the earjack 150. The controller 110 may determine the type of the connected earphone according to a voltage value input to the call key recognition terminal Ear_send. For example, when the voltage value input to the call key recognition terminal Ear_send is less than a predefined reference value, the controller 110 may determine that the three pole earphone is connected, and when the voltage value input to the call key recognition terminal Ear_send is equal to or higher than the predefined reference value, the controller 110 may determine that the four pole earphone is connected. When recognition of the type of the earphone is completed, the controller 110 may recognize the pressing of the call key 310 through the call key recognition terminal Ear_send. For example, the controller 110 may recognize the pressing of the call key 310 when the signal input through the call key recognition terminal Ear_send is changed from a high signal to a low signal.

After recognizing the type of the earphone, the controller 110 may determine whether the re-recognition of the earphone is requested. For example, the re-recognition of the earphone type may be generated when the user connects the four pole earphone 300 to the earjack 150 while pressing the call key 310 of the four pole earphone 300 and then releases the pressing of the call key 310. The controller 110 may determine that the earphone re-recognition request is generated when a signal input to the re-recognition terminal Ear_rereg is changed from a low signal to a high signal. When the re-recognition request is generated, the controller 110 may re-recognize the type of the earphone.

The controller 110 may control to re-recognize the earphone type only when the earphone re-recognition is requested in a circumstance where it is recognized that the three pole earphone is connected. When it is recognized that the four pole earphone 300 is connected, the controller 110 may disable the re-recognition terminal Ear_rereg. The purpose of this is to prevent a load from being applied to the controller 110 of the portable terminal 100 whenever the earphone re-recognition request is generated in response to pressing and releasing of the call key 310 of the four pole earphone 300. The controller 110 may determine whether the earphone connection is released, and when release of the earphone connection is detected, may enable the disabled re-recognition terminal Ear_rereg. Alternatively, the controller may maintain a disenabled state of the re-recognition terminal Ear_rereg and enable the re-recognition terminal Ear_rereg when the earphone connection is detected.

Although not shown in FIG. 1, the portable terminal 100 may further selectively include components having additional functions such as, for example, a camera module for capturing an image or a video, a short range communication module for enabling short range wireless communication, a broadcast receiving module for receiving broadcast, a sound reproducing module such as an MP3 module, or an internet communication module for performing an internet function. Such structural elements may be variously changed according to convergence trend; however, the portable terminal 100 may further include structural elements equivalent to the foregoing structural elements.

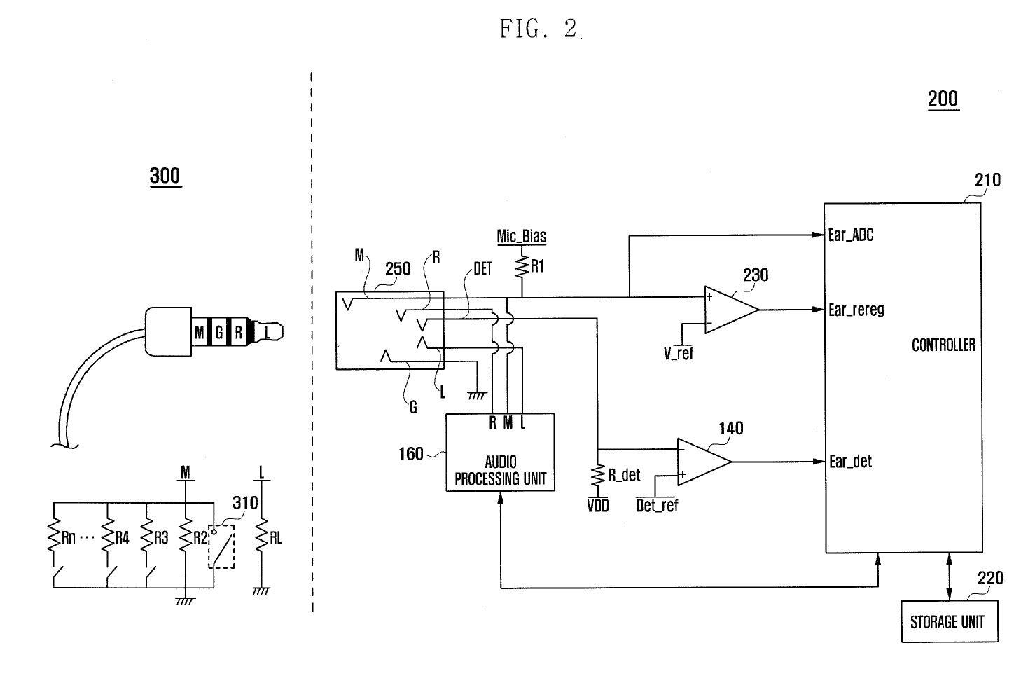

FIG. 2 is a schematic view illustrating a configuration of an earphone and a portable terminal according to a second exemplary embodiment of the present invention.

Referring to FIG. 2, the configuration of a portable terminal 200 according to the second exemplary embodiment of the present invention is similar to the portable terminal 100 according to the first exemplary embodiment. Accordingly, descriptions of similar elements of the second portable terminal 200 with the first portable terminal 100 will be omitted.

The four pole earphone 300 may further include a volume control key, a music playback key, a next song playback key, a previous song playback key, and a hold key, in addition to call key 310. Various keys as described above are connected parallel to a microphone terminal M of the earphone 300. Each key includes a resistor different from one another.

The portable terminal 200 may include a re-recognition detection unit 230 that compares an output voltage of the microphone terminal M of the earjack 150 with a predefined reference voltage V_ref to output a re-recognition signal. An output signal of the re-recognition detection unit 230 is input to a re-recognition terminal Ear_rereg of a controller 210. The portable terminal 200 may include a key recognition terminal Ear_ADC connected to the microphone terminal M of the earjack 250. The controller 210 may convert an analog voltage value input through the key recognition terminal Ear_ADC and recognize, for example, the call key 310, the music playback key, the previous song playback key, the next song playback key, according to a converted digital value. A storage unit 220 may include a key recognition table as shown in Table 1 below.

TABLE 1

| Output Voltage (V) of Microphone | |
|---|---|
| Terminal | Key Type |
| 1.8 | Next Song Playback Key |
| 1.4 | Previous Song Playback Key |
| 1.1 | Volume Up Key |
| 0.7 | Volume Down Key |
| 0.4 | Play Key |
| 0 | Call Key |

Table 1 is given as an example, but exemplary embodiments of the present invention are not limited thereto. The key recognition table may be variously modified according to the designer's intent. For example, according to another exemplary embodiment of the present invention, the output voltage of the microphone terminal corresponding to each key may be set differently or the key mapped to the microphone terminal may be varied.

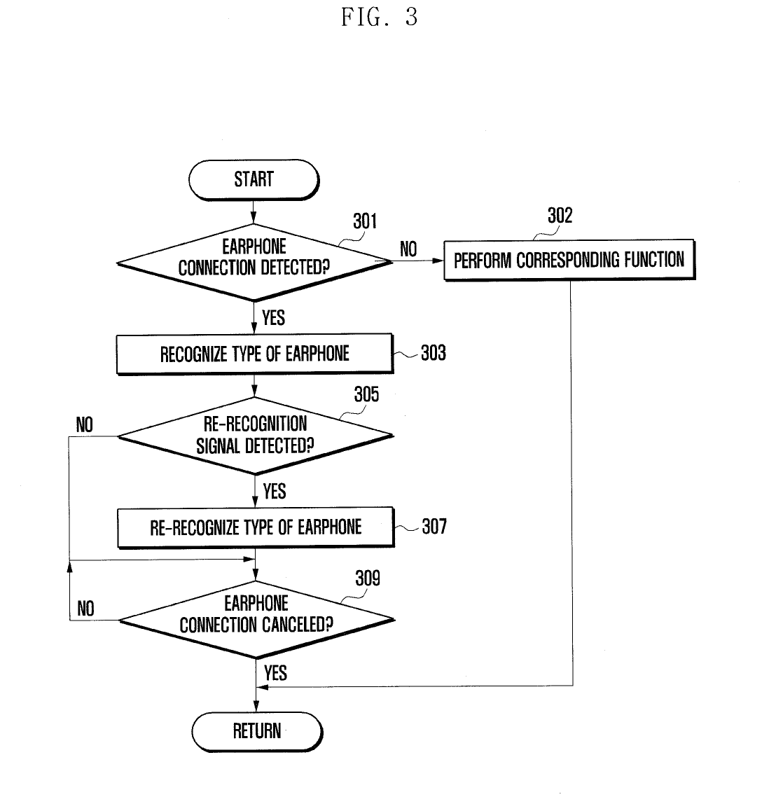

FIG. 3 is a flowchart illustrating a method of recognizing an earphone in a portable terminal according to an exemplary embodiment of the present invention. For illustrative purposes, the following description will be made with respect to the portable terminal 100; however, the method of FIG. 3 may be adapted for the portable terminal 200 as well.

Referring to FIG. 3, the controller 110 determines whether the earphone connection is detected in step 301. The earphone connection may be detected through the earphone detection unit 140, as described above. The controller 110 may determine that the earphone is connected when a high signal having a level equal to or greater than a predefined value is applied to the detection terminal Ear_det. Alternatively, depending on the designer's intent, the controller 110 may determine that the earphone is connected when a low signal having a level below the predefined value is applied to the detection terminal Ear_det. When the connection to the earphone is not detected, the controller 110 performs a corresponding function in step 302. For example, the controller 110 may perform a music play function, a photographing function or a broadcast receiving function according to a user's request or maintain a standby state.

When the earphone connection is detected, the controller 110 recognizes the type of the earphone in step 303. The controller 110 may determine the output voltage of the microphone terminal M of the earjack 150. When the output voltage of the microphone terminal M of the earjack 150 is a low signal, the controller 110 may recognize that the three pole earphone is connected to the earjack 150, and when the output voltage of the microphone terminal M of the earjack 150 is a high signal, the controller 110 may recognize that the four pole earphone is connected to the earjack 150. When recognition of the type of the earphone is completed, the controller 110 determines whether re-recognition of the earphone type is requested in step 305. The controller 110 may determine whether a high signal is input to the re-recognition terminal Ear_rereg. The re-recognition request of the earphone type may be generated when the four pole earphone is connected to the earjack 150 while the call key 310 of the four pole earphone is pressed and then the pressing of the call key 310 is released. The re-recognition request of the earphone type may be generated whenever the call key 310 of the four pole earphone is pressed and released. Such approach to re-recognizing the type of the earphone applies a load to the portable terminal 100 and is thus inefficient. Accordingly, the earphone type may be re-recognized only when the re-recognition of the earphone type is requested in a circumstance where connection to the three pole earphone is recognized. When connection to the four pole earphone 300 is recognized, the controller 110 may disable the re-recognition terminal Ear_rereg.

When the re-recognition of the earphone type is not requested, the controller 110 may proceed to step 309, which is discussed below. When the re-recognition of the earphone type is requested, the controller 110 may re-recognize the type of the earphone that is connected to the earjack 150 in step 307. The controller 110 may re-determine whether the output voltage of the microphone terminal M of the earjack 150 is high or low. When connection to the four pole earphone 300 is recognized according to a result of re-recognition, the controller 110 may disable the re-recognition terminal Ear_rereg.

The controller 110 determines whether connection to the earphone is canceled in step 309. For example, when the signal input to the detection terminal Ear_det is changed from high to low, the controller 110 may recognize that the connection to the earphone is canceled. Where the signal input to the detection terminal Ear_det is changed from low to high, the connection to the earphone may be recognized as being canceled according to a designer's intention discussed above.

When the connection to the earphone is not canceled in step 309, the controller 110 may maintain step 309. When the connection to the earphone is canceled, the controller 110 may return to step 301 to repeat the above process. The controller 110 may enable the re-recognition terminal Ear_rereg. Otherwise, the controller 110 may maintain the disable state of the re-recognition terminal Ear_rereg and enable the re-recognition terminal Ear_rereg when the connection to the earphone is detected.

According to exemplary embodiments of the present invention described above, when the four pole earphone 300 is connected while the user presses the call key 310 such that the four pole earphone 300 is misrecognized, the type of the earphone may be re-recognized when the pressing of the call key 310 is canceled. According, an issue of erroneous recognition of the earphone when connecting the four pole earphone to the portable terminal while the call key 310 is pressed may be addressed.

As described above, in the method and the apparatus for recognizing the earphone of the portable terminal according to an exemplary embodiment of the present invention, an issue where the four pole earphone is misrecognized as the three pole earphone when connected to the portable terminal while the call key is pressed may be addressed. Therefore, according to the present invention, a situation where the user may mistakenly determine that the portable terminal or the four pole earphone is broken may be avoided, thereby providing reliability to the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method of recognizing an earphone in a portable terminal, the method comprising:
detecting a connection to the earphone;
recognizing a type of the connected earphone;
determining whether a re-recognition signal of the connected earphone is input; and
re-recognizing the type of the connected earphone when the re-recognition signal is input.

2. The method according to claim 1, wherein the re-recognition signal is generated when the type of the connected earphone is misrecognized due to pressing of a call key of the earphone and the pressing of the call key is canceled.

3. The method according to claim 1, wherein the recognizing of the type of the connected earphone and the re-recognizing of the type of the connected earphone comprise:
recognizing a four pole earphone when an output voltage of a microphone terminal of an earjack to which the earphone is connected is equal to or higher than a predetermined reference value; and
recognizing a three pole earphone when the output voltage of the microphone terminal of the earjack to which the earphone is connected is lower than the predetermined reference value.

4. The method according to claim 3, wherein, when the connection to the four pole earphone is recognized, a re-recognition terminal to which the re-recognition signal is input is disabled.

5. The method according to claim 4, further comprising:
determining whether the connection to the earphone is canceled; and
enabling the disabled re-recognition terminal when the connection to the earphone is canceled.

6. The method according to claim 4, further comprising:
determining whether the connection to the earphone is canceled; and
maintaining a disabled state of the re-recognition terminal when the connection to the earphone is canceled and enabling the re-recognition terminal when the connection to the earphone is detected.

7. An apparatus for recognizing an earphone in a portable terminal, the apparatus comprising:
an earjack for receiving the earphone; and
a controller for recognizing a type of a connected earphone when connection to the earphone is detected, for determining whether a re-recognition signal of the connected earphone is input, and for controlling to re-recognize the type of the connected earphone when the re-recognition signal is input.

8. The apparatus according to claim 7, wherein the controller comprises:
a detection terminal for detecting the connection to the earphone;
a key recognition terminal for recognizing the type of the earphone and for recognizing pressing of a key included in the earphone; and
a re-recognition terminal for detecting an input of the re-recognition signal.

9. The apparatus according to claim 7, wherein the controller recognizes a four pole earphone when an output voltage of a microphone terminal of the earjack to which the earphone is connected is equal to or higher than a predefined reference value and recognizes a three pole earphone when the output voltage of the microphone terminal of the earjack to which the earphone is connected is lower than the predefined reference value.

10. The apparatus according to claim 9, wherein, when connection to the four pole earphone is recognized, the controller disables the re-recognition terminal to which the re-recognition signal is input.

11. The apparatus according to claim 10, wherein, when the connection to the earphone is canceled, the controller enables the disabled re-recognition terminal.

12. The apparatus according to claim 10, wherein, when the connection to the earphone is canceled, the controller maintains a disabled state of the re-recognition terminal, and enables the re-recognition terminal when the connection to the earphone is detected.

13. The apparatus according to claim 7, further comprising:
a storage unit for storing a key recognition table for distinctly recognizing a plurality of keys included in the earphone.

14. The apparatus according to claim 7, further comprising:
a call key recognition unit for recognizing pressing of a call key by comparing an output voltage of a microphone terminal of the earjack with a predefined reference voltage,
wherein the re-recognition signal is an output signal of the call key recognition unit.

15. The apparatus according to claim 14, wherein the re-recognition signal is the output signal of the call key recognition unit generated when the type of the connected earphone is misrecognized due to pressing of the call key of the earphone and the pressing of the call key is canceled.

16. The apparatus according to claim 7, further comprising:
a re-recognition detection unit for comparing an output voltage of a microphone terminal of the earjack with a predefined reference value to output the re-recognition signal,
wherein the re-recognition signal is an output signal of the re-recognition detection unit.

17. The apparatus according to claim 16, wherein the re-recognition signal is generated when the type of the connected earphone is misrecognized due to pressing of a call key of the earphone and the pressing of the call key is canceled.

18. A portable terminal, comprising:
an earjack arranged to receive a three pole earphone and a four pole earphone;
a controller for recognizing a type of an earphone inserted into the earjack, for determining whether a re-recognition of the inserted earphone is input, and for re-recognizing the type of the inserted earphone when the re-recognition symbol is input; and
an audio processor for receiving an audio signal input from a microphone of the inserted earphone, and for converting a data signal into an analog signal for output to the inserted earphone.

19. The portable terminal of claim 18, wherein the controller recognizes input of a call key based on a voltage output from a microphone terminal of the earjack.
